(19) United States
(12) Patent Application Publication
(10) Pub. No.: US 2026/0267625 A1
(43) Pub. Date: Sep. 10, 2026

(54) Computer-Implemented Method and System for Generating a Command Pipeline for Controlling a Technical Device

(71) Applicant: Siemens Aktiengesellschaft, Muenchen (DE)

(72) Inventors: Andrei Laurentiu COMAN, Brasov (RO); Alexandru CHIS, Brasov (RO); Delia Elena IUGA, Brasov (RO); Carlos MORRA, Berlin (DE)

(21) Appl. No.: 18/871,896

(22) PCT Filed: Jun. 2, 2023
(86) PCT No.: PCT/EP2023/064814

§ 371 Date: Dec. 5, 2024

(30) Foreign Application Priority Data
Jun. 9, 2022 (EP) 22465539.9

(51) Int. Cl. G06F 8/41; G06F 8/30

(52) U.S. Cl. CPC G06F 8/4452; G06F 8/31

(57) ABSTRACT

A computer-implemented method for generating a command pipeline as a continuous integration pipeline for controlling a technical device by a generation device includes a) providing a first command pipeline with first commands for the generation device from a local database, b) providing at least one second command pipeline with second commands for the generation device, c) determining similarities between the first and the at least one second command pipeline by the generation device, d) identifying at least one similarity between the first and the at least one second command pipeline by the generation device, and based on a predefined threshold for the at least one similarity, and selecting the at least one second command pipeline as a generated pipeline, when the threshold is exceeded by the at least one similarity, and e) providing the generated pipeline to a command device and controlling the technical device with the generated pipeline.

### CROSS-REFERENCE TO RELATED APPLICATIONS

This is a U.S. national stage of application No. PCT/EP2023/064814 filed 2 Jun. 2023. Priority is claimed on European Application No. 22465539.9 filed 9 Jun. 2022, the content of which is incorporated herein by reference in its entirety.

### BACKGROUND OF THE INVENTION

### 1. Field of the Invention

The invention relates to a computer program, an electronically readable data carrier, a data carrier signal and a computer-implemented method and a system for generating a command pipeline as a continuous integration pipeline for controlling a technical device by a generation device.

### 2. Description of the Related Art

In software engineering, combined practices of “Continuous Integration” (CI) and “Continuous Deployment and Delivery” (CD) are applied, abbreviated with “CI/CD”, which is illustrated in FIG. 1.

CI/CD is a way of developing software in which it is foreseen to release updates at any time in a sustainable way. When changing code is routine, development cycles are more frequent, meaningful, and faster.

The Continuous Integration CI is represented by the process sequence Build CI_B, Code CI_C, Plan CI_P and Test CI_T.

The Continuous Deployment and Delivery CD is represented by the process sequence Deploy CD_D, Monitor CD_M, Operate CD_O and Release CD_R.

A CI/CD pipeline automates the software delivery process. The pipeline builds code, runs tests (CI), and safely deploys a new version of the application (CD).

Automated pipelines remove manual errors, provide standardized feedback loops to developers, and enable fast product iterations.

FIG. 2 shows the stages of a CI/CD pipeline in accordance with the prior art.

Starting from a software source SRC, including a global database push GDB_P, a software build BUI phase is executed, including compiling COMP and docker build DBLT phase for a container application.

Subsequently, a software test phase TEST includes a smoke phase SMOKE, a unit phase UNIT and an integration phase INT, followed by a deployment phase DPL with a staging phase STA leading to a production phase PROD.

Writing Continuous Integration/Continuous Deployment and Delivery (CI/CD) pipelines is a repetitive and tedious activity that is usually performed manually and requires a lot of project specific scripts that are hard to maintain and/or reuse.

In the known art, the creation of CI/CD pipelines is usually performed in a manual manner and is project specific. Some of the components, scripts or the configuration of the pipeline can be copied and adapted for similar projects.

However, the identification of the projects and which components can be reused is usually performed manually based on the experience of an expert and, thus, a manual step.

The detection of similar repositories like on GitHub was already discussed. Nonetheless, the automatic generation of pipeline based on similar repositories has not been addressed in any previous work.

US Pub. No. 2019/258976 A1 discloses techniques for generating pipeline object recommendations for software development projects. However, it is related only to software development and not for software for controlling hardware devices. Moreover, the object recommendations are related to development attributes, such as data storage or software development elements or tools.

### SUMMARY OF THE INVENTION

In view of the foregoing, it is therefore an object of the invention to provide a method for automating pipeline creation via analysis of similarity to previous projects and reuse of pipeline definitions to achieve a higher level of automation, to increase the internal processes at software development, to enhance the performance of the software and to minimize misfunctions.

These and other objects and advantages are achieved in accordance with the invention by a computer-implemented method for generating a command pipeline for the control of a technical device, comprising:
a) Providing a first command pipeline with first commands for the generation device from a first database,
b) Providing at least one second command pipeline with second commands for the generation device from at least one second database,
c) Determining similarities between the first and the at least one second command pipeline by the generation device,
d) Identifying at least one similarity between the first and the at least one second command pipeline by the generation device, and based on a predefined threshold for the at least one similarity, and selecting the at least one second command pipeline as a generated pipeline, when the threshold is exceeded by the at least one similarity,
e) Providing the generated pipeline to a command device and controlling the technical device with the generated pipeline.

Thereby, the new first command pipeline is replaced by a similar second pipeline, which is already known and approved. Therefore, further engineering efforts such as testing can be reduced.

The first data base can be a local data base, providing a first command pipeline for controlling the technical device. The second data base can be a global data base, providing a second, for instance, an approved or verified command pipeline for controlling the technical device.

A command pipeline in general is an instruction sequence containing commands.

The predefined threshold can be defined manually or automatically using predefined quality parameters.

Further, when determining similarities at step c) an error measure is utilized based on the sum of squared differences in accordance with the following relationship:

$$M ( w , p , {r}_{j} ) = {\sum }_{i = 1}^{n} {{w}_{i} ( {p}_{i} - {r}_{i , j} )}^{2}$$

where
   pᵢ, r_{i,j} are percentages of programming or scripting languages in the local and remote projects, e.g., via number of lines of code, number of code modules, represented by the first and the at least one second command pipeline, respectively,
   wᵢ represents the relevance to each language, represented by the first and the at least one second command pipeline, assigned manually by an user, which must be positive numbers and

$${\sum }_{i = 1}^{n} {w}_{i} = 1 ,$$

n is the maximum number of programming languages from local and remote projects, represented by the first and the at least one second command pipeline,
i is the index of a programming language for the first and the at least one second command pipeline,
j is the number of the remote project, represented by the first and the at least one second command pipeline,
   and the most similar project j, out of the first and the at least one second command pipeline, corresponds to the minimum Value of M(w,p,rⱼ).

The selection of the portion of common or similar programming or scripting languages in the local and remote projects, such as lines or code or number of software modules, within the squared difference as an error measure, leads to the advantage, that by this an easy way for comparing pipelines is found, which can be implemented very efficient and with low complexity.

In conjunction with a weight on the programming or scripting language, the performance at the similarity determination can be further improved and a beneficial effect on the overall efficiency can be achieved.

The counter i at the sum in the above-relationship, counts through all different languages, with the maximum number m of programming languages, from local and remote projects.

In other words, the inventive method provides most similar pipelines with respect to the similarity of used programming or scripting languages. Thus, an improvement by an inherent reduction of resulting errors or bugs in the selected pipeline is achieved, because less interface adaptions were included, which could be subject for implicit bugs and errors of the total codes or scripts.

In an embodiment, the percentages of programming or scripting languages in the local and remote projects are determined by using the number of code lines or software modules in the same language.

Thus, the similarity represents the function on the code itself and the impact on more bugs and errors within the code can be limited. By using the length of the code as a basis for the similarity assessment regarding programming or scripting language, the result is a very reliable command pipeline.

In a further embodiment, the determination of similarities during step c) is performed for all of the at least one command pipeline, and a sorted list of all of the at least one command pipeline is generated in accordance with the similarity achieved before, and when selecting the at least one second command pipeline as a generated pipeline, the item of the list is selected, which provides the lowest error measure in accordance with the inventive method.

In other words, the command pipeline is selected from the at least one command pipeline, which provides the lowest error measure and thus, is most similar to the first command pipeline.

Using the lowest error measure as defined before provides a very simple, accurate and representative measure for the similarity when comparing command pipelines regarding their programming language and/or syntax and/or semantics.

The objects and advantages are also achieved in accordance with the invention by a system for generating a command pipeline for the control of a technical device, where the system comprises a first and at least one second database, a generation device and a command device, and where the system is configured to execute the method in accordance with the disclosed embodiments.

The objects and advantages are also achieved in accordance with the invention by a computer-program-product with machine-readable instructions stored therein which, when executed cause a processing unit or processor to execute the method in accordance with the disclosed embodiments.

The objects and advantages are also achieved in accordance with the invention by a computer program, comprising instructions which, when executed, cause a computer to execute the steps of the method in accordance with the disclosed embodiments.

The objects and advantages are also achieved in accordance with the invention by an electronically readable data carrier with readable control information stored thereon, which comprise the computer program in accordance with disclosed embodiment and which is configured to control a processing device, when using the data carrier at the processing device, and configured to execute the steps of the method in accordance with the disclosed embodiments.

The objects and advantages are also achieved in accordance with the invention by a data carrier signal, transmitting the computer program in accordance with disclosed embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described in an exemplary embodiment presented in detail in the subsequent figures, in which:

FIG. 1 an illustration of an overview of a CI/CD pipeline in accordance with the prior art;

FIG. 2 illustrates stages of a CI/CD pipeline in accordance with the prior art;

FIG. 3 is a schematic block diagram of a first embodiment of a system in accordance with the invention;

FIG. 4 is an illustration of an embodiment of the general process to synchronize data between entities of the system in accordance with the invention;

FIG. 5 is an illustration of an embodiment of the synchronization process between entities of the system in accordance with the invention;

FIG. 6 is an illustration of an embodiment with further details of the synchronization process between entities of the system in accordance with the invention;

FIG. 7 is an embodiment of a flow chart of the method in accordance with the invention; and

FIG. 8 is a schematic block diagram of the system in accordance with an embodiment of the invention.

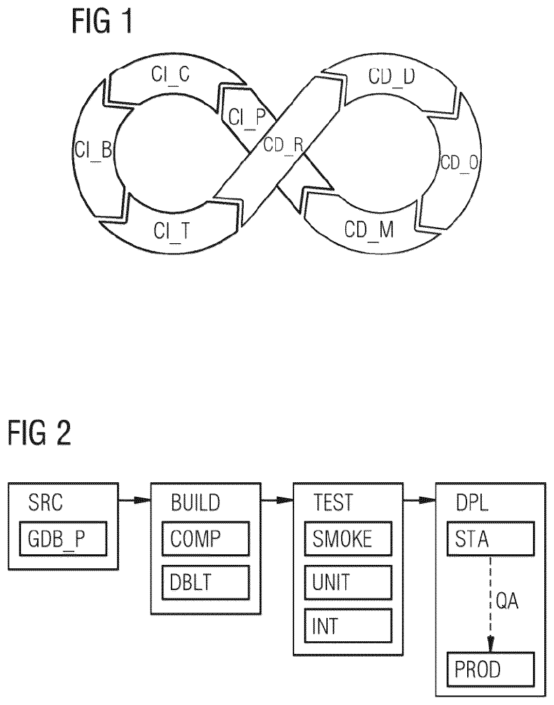

### DETAILED DESCRIPTION OF THE EXEMPLARY EMBODIMENTS

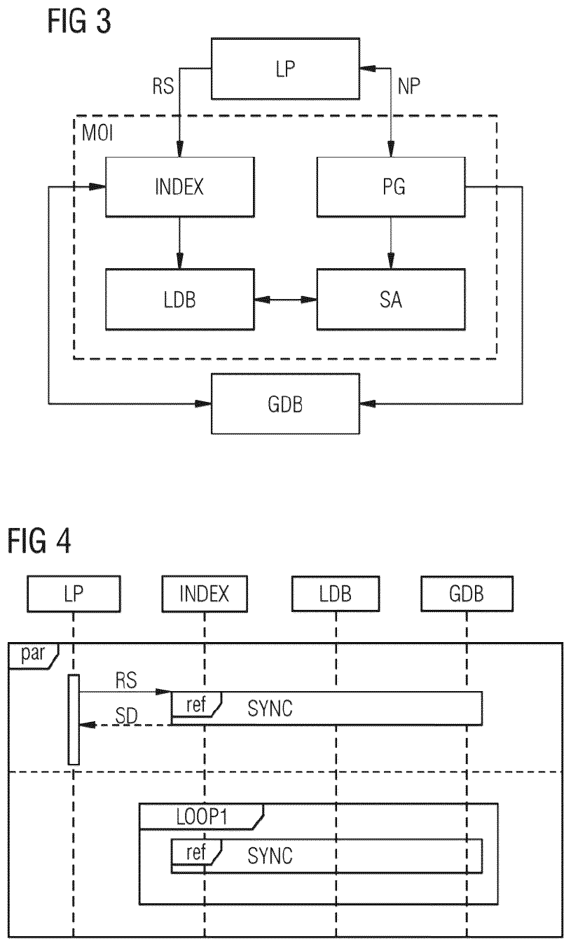

FIG. 3 shows a schematic block diagram of a system in accordance with an embodiment of the invention;

The invention proposes a method for automating the pipeline creation via analysis, i.e., determination of similarity to previous projects and reuse of pipeline definitions.

Four major components are used by a system executing the method in accordance with the invention, i.e., an indexer INDEX, a pipeline generator PG, a similarity analyzer SA and a local database LDB, which are involved in the process along the external components as a local project LP and a global database GDB like a GitLab instance, and the interaction among them are presented in FIG. 3 showing the method in accordance with the invention MAI as an exemplary embodiment.

The pipeline generator PG generates the configuration and code for the instantiation of the pipeline and the connection of the CI/CD tools.

The similarity Analyzer SA analyzes and determines the project properties and compares it to existing projects in the repositories.

The local database LDB stores the properties of the projects in the repositories.

The indexer INDEX monitors the repositories for changes and updates the local database.

The global database GDB, e.g. a Gitlab Instance, stores the repositories.

When a new CI/CD Pipeline definition is required by the local project LP, on a new pipeline demand NP, the pipeline generator PG supported by the similarity analyzer SA returns the most relevant configuration.

The local database LDB allows both synchronous and asynchronous updates of the content retrieved from the Git Lab instance, on a synchronization request RS.

This update is performed by the indexer INDEX, which queries the GitLab API for the most recent changes in the repository.

FIG. 4 shows a general process to synchronize data between entities of the system in accordance with the invention.

The local project requests synchronization RS, where the related entity performs respective actions by a synchronization step SYNC and signalizes subsequently by synchronization done SD.

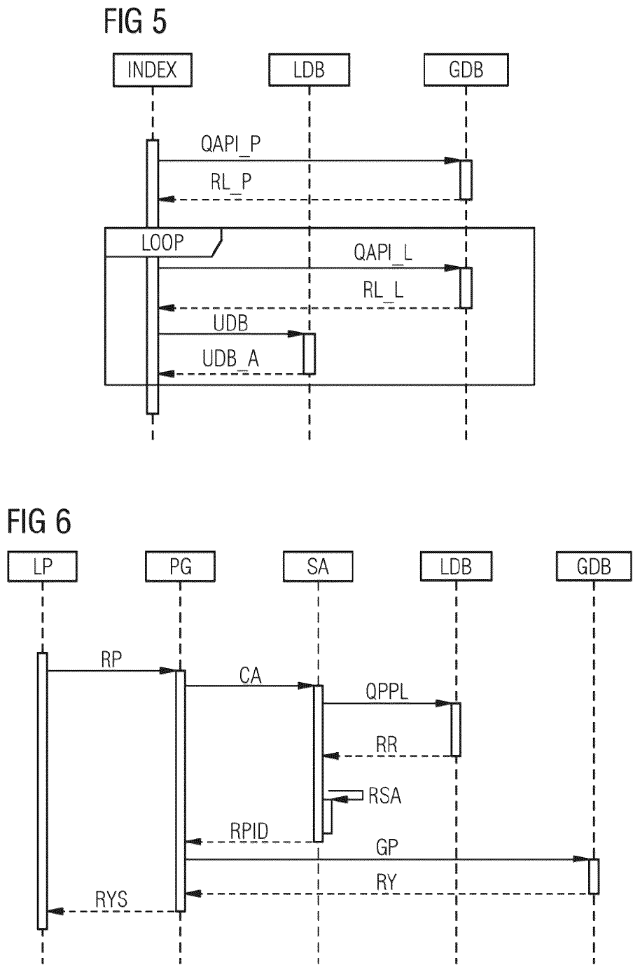

As depicted in FIG. 5, when a synchronization is called, the indexer INDEX will request the list of projects from the backing Git instance (Gitlab) and, for each of them, update the respective entries in the local database LDB with the new values for the programming languages code percentages. The new values can now be used to provide more accurate references to similar projects from which to match and grab the pipeline structure.

Optionally one or more synchronization steps SYNC can be repeated, indicated by the general reference LOOP.

Within the sequence diagram a “par” notation is used to indicate a “parallel” process.

FIG. 4 shows that the synchronization process can occur synchronously or asynchronously, so either is triggered explicitly by the local project and/or is handled on an external trigger, e.g., a cron job (job scheduling utility).

Within the sequence diagram, a “ref” notation is used for a reference. It is to show that another sequence, e.g., in FIG. 5 is called that impacts the three actors on top, indexer INDEX, local database LDB and Gitlab instance/global database GDB.

To generate a new pipeline configuration for the local project LP, the following steps are executed, which are also depicted in FIGS. 5 to 7:
a) The indexer INDEX is triggered, for instance, by a scheduler or a developer.
b) The indexer INDEX queries with a the GitLab instance GDB to update the local database LDB with remote projects and their respective programming with a command QAPI_P and/or scripting languages with a command QAPI_P QAPI_L usage percentages. The GitLab instance GDB provides a respective return list for language RL_L and/or a return list for project RL_P. If necessary, the queries are repeated within a loop LOOP. Subsequently, the indexer INDEX updates the local database LDB accordingly by signal UDB and receives optionally an acknowledge signal UDB_A.
c) The similarity analyzer provides an algorithm, which uses an error measure based on the sum of squared differences in accordance with the following relationship:

$$M ( w , p , {r}_{j} ) = {\sum }_{i = 1}^{n} {{w}_{i} ( {p}_{i} - {r}_{i , j} )}^{2}$$

where
pᵢ, r_{i,j} are the percentages of programming or scripting languages in the local and remote projects, respectively,
wᵢ represents the relevance the user assigns to each language, which must be positive numbers and

$${\sum }_{i = 1}^{n} {w}_{i} = 1 ,$$

n is the maximum number of programming languages from local and remote projects,
i is the index of the programming language,
j is the number of the remote project.

The most similar project j corresponds to the minimum value of M(w, p,rⱼ).

First, the local project LP performs a request pipeline RP call to the pipeline generator PG.

The pipeline generator PG calls the similarity analyzer SA with a call analyzer CA, which performs the described algorithm before using signals for query project and pipeline QPPL and delivers a return result RR.

The similarity analyzer SA runs similarity determination, i.e., analysis RSA and returns with step RPID a return project ID to the pipeline generator PG.

The pipeline generator PG calls step GP to get pipeline YAML from a Git repository REPO.

GitLab uses the simplified markup language “Yet Another Markup Language” (YAML) for data serialization to define the structure of a CI/CD Pipeline. By YAML a reference to the pipeline configuration of a specific project is made.

The similarity analyzer SA returns by return YAML RY at most one project which is below the error threshold, in particular by the return YAML structure RYS.

For a Gitlab pipeline configuration file, any specificity regarding the original project is to be removed, and the configuration returned by the Gitlab Instance will go through an internal process in the Pipeline Generator which will sanitize it: remove comments, references to customer environment variables etc. Only a skeleton should be left which details the overall flow of the pipeline.
d) Based on a predefined threshold, the remote project selected at step c) is accepted or not.
e) The pipeline generator PG receives the accepted project and fetches its CI/CD pipeline configuration from the remote GitLab Instance GDB.
f) The pipeline generator PG then parses this configuration and returns the template back to the local project LP, by involving the indexer INDEX optionally.

Based on the predefined threshold for the at least one similarity, the remote or at least one second command pipeline is selected as a generated pipeline, when the threshold is exceeded by the at least one similarity.

It should be understood, for all embodiments, a predefined value range equals to a previous threshold with which a value can be compared, and the predefined value range comprises two thresholds, which can be exceeded in two directions, i.e., a value falls below a predefined minimum or exceeds a predefined maximum.

In practice, if more than one pipeline exceeds the predefined threshold, then the pipeline with the highest degree on similarity can be chosen.

The indexer INDEX updates the local database LDB accordingly by signal UDB. Doing so, the pipeline configurations are not stored in the database. In order to determine the best project from which to grab the pipeline skeleton, the algorithm uses only the languages information, so the local database can be thought of as a cache for those. When the response from GitLab GDB with the language information is received for a specific project, the percentage of each language for that project is updated in the database and can be used right away by the similarity analyzer.

As mentioned previously, the pipeline configuration is not stored in the local database LDB. After the best project has been identified, the Configuration needs to be fetched from the repository backing that specific GitLab project.

At step f) pipeline generator PG returns the template back to the LP local project. However, the indexer INDEX is only involved in scraping Gitlab Projects and in the synchronization process.

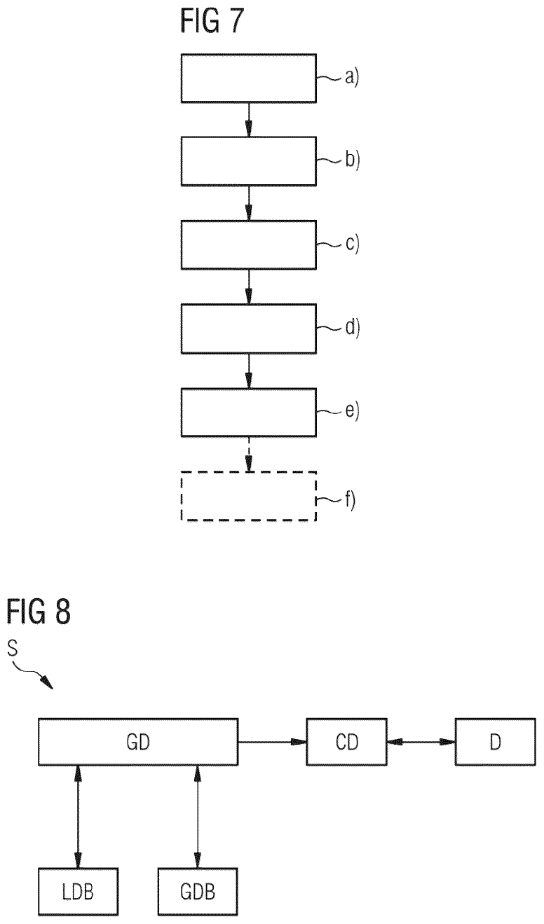

FIG. 7 shows an embodiment with a simplified flow chart of the method in accordance with the invention.

Step f) as described above is optional.

FIG. 8 shows simplified schematic block diagram of a system S in accordance with and embodiment of the invention.

The system S for generating a command pipeline for controlling a technical device D comprises a first and at least one second database LDB, GDB, a generation device GD, a command device CD for controlling the technical device D.

The system is configured to execute the steps of the method in accordance with disclosed embodiments of the invention.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-5. (canceled)

6. A computer-implemented method for generating a command pipeline as a continuous integration pipeline for controlling a technical device (D) by a generation device, the method comprising:
a) providing a first command pipeline with first commands for the generation device from a first database;
b) providing at least one second command pipeline with second commands for the generation device from at least one second database;
c) determining similarities between the first and the at least one second command pipeline by the generation device;
e) identifying at least one similarity between the first and the at least one second command pipeline by the generation device, and based on a predefined threshold for the at least one similarity, and selecting the at least one second command pipeline as a generated pipeline, when the predefined threshold is exceeded by the at least one similarity; and
f) providing the generated pipeline to a command device and controlling the technical device (D) based on the generated pipeline;
wherein when determining similarities during step c), an error measure based on a sum of squared differences in accordance with the following relation is utilized:
$$M ( w , p , {r}_{j} ) = {\sum }_{i = 1}^{n} {{w}_{i} ( {p}_{i} - {r}_{i , j} )}^{2} ,$$
where
pᵢ and r_{i,j} are percentages of programming or scripting languages in local and remote projects, represented by the first and the at least one second command pipeline, respectively,
wᵢ represents a relevance to each language, represented by the first and the at least one second command pipeline, assigned manually by an user, which must be positive numbers and
$${\sum }_{i = 1}^{n} {w}_{i} = 1 ,$$
n is a maximum number of programming languages from the local and remote projects, represented by the first and the at least one second command pipeline,
i is an index of a programming language for the first and the at least one second command pipeline, and
j is ae number of the remote project, represented by the first and the at least one second command pipeline, and a most similar project j, out of the first and the at least one second command pipeline, corresponds to the minimum value of M(w,p,rⱼ).

7. The method according to claim 6, wherein percentages of programming or scripting languages in the local and remote projects is determined by utilizing a number of code lines or software modules in the same language.

8. The method according to claim 6, wherein said determining similarities during step c) is performed for all of the at least one command pipeline, and a sorted list of all of the at least one command pipeline is generated in accordance to the similarity achieved before, and when selecting the at least one second command pipeline as a generated pipeline, an item of the list is selected, which provides a lowest error measure.

9. A system for generating a command pipeline for controlling a technical device, comprising:
a first and at least one second database;
a generation device; and
a command device for controlling the technical device;
wherein the system is configured to:
a) provide a first command pipeline with first commands for the generation device from a first database;
b) provide at least one second command pipeline with second commands for the generation device from at least one second database;
c) determine similarities between the first and the at least one second command pipeline by the generation device;
e) identify at least one similarity between the first and the at least one second command pipeline by the generation device, and based on a predefined threshold for the at least one similarity, and selecting the at least one second command pipeline as a generated pipeline, when the predefined threshold is exceeded by the at least one similarity; and
f) provide the generated pipeline to a command device and control the technical device (D) based on the generated pipeline; and
wherein when determining similarities during step c), an error measure based on a sum of squared differences in accordance with the following relation is utilized:
$$M ( w , p , {r}_{j} ) = {\sum }_{i = 1}^{n} {{w}_{i} ( {p}_{i} - {r}_{i , j} )}^{2} ,$$
where
pᵢ and r_{i,j} are percentages of programming or scripting languages in local and remote projects, represented by the first and the at least one second command pipeline, respectively,
wᵢ represents a relevance to each language, represented by the first and the at least one second command pipeline, assigned manually by an user, which must be positive numbers and
$${\sum }_{i = 1}^{n} {w}_{i} = 1 ,$$
n is a maximum number of programming languages from the local and remote projects, represented by the first and the at least one second command pipeline,
i is an index of a programming language for the first and the at least one second command pipeline, and
j is ae number of the remote project, represented by the first and the at least one second command pipeline, and a most similar project j, out of the first and the at least one second command pipeline, corresponds to the minimum value of M(w,p,rⱼ).

10. A non-transitory computer-readable medium encode with machine-readable instructions which, when executed by a processor, causes the processor to generate a command pipeline as a continuous integration pipeline for controlling a technical device by a generation device, the instructions comprising:
a) program code for providing a first command pipeline with first commands for the generation device from a first database;
b) program code for providing at least one second command pipeline with second commands for the generation device from at least one second database;
c) program code for determining similarities between the first and the at least one second command pipeline by the generation device;
e) program code for identifying at least one similarity between the first and the at least one second command pipeline by the generation device, and based on a predefined threshold for the at least one similarity, and selecting the at least one second command pipeline as a generated pipeline, when the predefined threshold is exceeded by the at least one similarity; and
f) program code for providing the generated pipeline to a command device and controlling the technical device based on the generated pipeline;
wherein when determining similarities during step c), an error measure based on a sum of squared differences in accordance with the following relation is utilized:
$$M ( w , p , {r}_{j} ) = {\sum }_{i = 1}^{n} {{w}_{i} ( {p}_{i} - {r}_{i , j} )}^{2} ,$$
where
pᵢ and r_{i,j} are percentages of programming or scripting languages in local and remote projects, represented by the first and the at least one second command pipeline, respectively,
wᵢ represents a relevance to each language, represented by the first and the at least one second command pipeline, assigned manually by an user, which must be positive numbers and
$${\sum }_{i = 1}^{n} {w}_{i} = 1 ,$$
n is a maximum number of programming languages from the local and remote projects, represented by the first and the at least one second command pipeline,
i is an index of a programming language for the first and the at least one second command pipeline, and
j is ae number of the remote project, represented by the first and the at least one second command pipeline, and a most similar project j, out of the first and the at least one second command pipeline, corresponds to the minimum value of M(w,p,rⱼ).
